(19) United States
(12) Patent Application Publication
(10) Pub. No.: US 2004/0176128 A1
(43) Pub. Date: Sep. 9, 2004

(54) System, mobile communications unit, and softswitch method and apparatus for establishing an Internet Protocol communication link

(75) Inventors: David Grabelsky, Skokie, IL (US); Anoop Tripathi, Mount Prospect, IL (US); Guanglu Wang, Buffalo Grove, IL (US)

Correspondence Address: FITCH EVEN TABIN AND FLANNERY, 120 SOUTH LA SALLE STREET, SUITE 1600, CHICAGO, IL, 60603-3406, US

(73) Assignee: 3Com Corporation

(21) Appl. No.: 10/354,610

(22) Filed: Jan. 30, 2003

(51) Int. Cl. H04Q 7/20

(52) U.S. Cl. 455/553.1; 455/466

(57) ABSTRACT

When an Internet protocol connection for a given mobile communications unit already exists, that existing link can be used to conduct an Internet protocol communication with that mobile communications unit. When such a link does not already exist, and a need exists to convey information to the mobile communication unit via such a link, a message can be provided to the mobile communications unit via a non-Internet protocol wireless link to cause the mobile communications unit to self-initiate establishment of such an Internet protocol communications link. Upon establishing such a link, the requesting entity, service, or application can use that link to facilitate the desired Internet protocol-based communication.

### TECHNICAL FIELD

This invention relates generally to wireless communications and more particularly to wireless communications using Internet protocol communication links.

### BACKGROUND

Both wireless communications and Internet protocol-based communications have a present appearance of ubiquity. Notwithstanding such appearances, however, considerable gaps exist with respect to wireless Internet protocol-based communications. While numerous Internet-compatible standards are employed in wireless settings, many such wireless communications designs nevertheless lack a fully facilitated Internet protocol capability. For example, so-called 3G wireless networks typically permit Internet-compatible communications by supporting the point-to-point protocol (“PPP”). In particular, a 3G mobile communications unit can initiate setting up an Internet protocol compatible communications link (via PPP) and then use that link to conduct an Internet protocol-based communication session. Unfortunately, however, this same mobile communications unit cannot typically receive an Internet protocol-based communication unless and until the mobile communications unit has itself established a link as described above. With such an approach, the immediacy offered by the Internet may be largely lost for many users.

One solution is to continually maintain a wireless Internet protocol communication link for the mobile communication unit. Such an approach, however, to date proves largely unsatisfactory. Both airtime costs and bandwidth requirements to fully facilitate this approach are unduly large, and particularly so when considered as a solution for a potentially large number of users.

### BRIEF DESCRIPTION OF THE DRAWINGS

The above needs are at least partially met through provision of the system, mobile communications unit, and softswitch method and apparatus for establishing an internet protocol communication link described in the following detailed description, particularly when studied in conjunction with the drawings, wherein:

FIG. 1 comprises a general flow diagram as configured in accordance with an embodiment of the invention;

FIG. 2 comprises a block diagram of a softswitch as configured in accordance with an embodiment of the invention;

FIG. 3 comprises a flow diagram as configured in accordance with an embodiment of the invention;

FIG. 4 comprises a block diagram of a mobile communication unit as configured in accordance with an embodiment of the invention;

FIG. 5 comprises a flow diagram as configured in accordance with an embodiment of the invention;

FIG. 6 comprises a block system overview as configured in accordance with an embodiment of the invention;

FIG. 7 comprises a block system overview as configured in accordance with an embodiment of the invention;

FIG. 8 comprises a block system overview as configured in accordance with an embodiment of the invention;

FIG. 9 comprises a block system overview as configured in accordance with an embodiment of the invention;

FIG. 10 comprises a timing diagram as configured in accordance with one embodiment of the invention; and

FIG. 11 comprises a timing diagram as configured in accordance with another embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, when an Internet protocol communication need exists with respect to a given mobile station, and when an Internet protocol connection already exists, than that connection can serve to facilitate the desired communication. When, however, such an Internet protocol connection does not already exist, a wireless communication is provided to the mobile station, wherein the wireless communication comprises at least an instruction to self-initiate setting up a mobile-initiated-setup Internet protocol connection. Upon successfully establishing that connection, the setup of which was initiated by the mobile station, the connection then serves to permit the Internet protocol-based communication with the mobile station.

In one embodiment of the invention, the mobile-initiated-setup Internet protocol connection comprises the same setup process that the mobile would utilize when seeking to establish such a connection for other mobile-initiated purposes.

In one embodiment, the instruction is conveyed via a non-Internet protocol connection, such as, for example, a circuit network. In particular, the instruction can be conveyed using at least one of a non-Internet protocol communications system control channel, a non-Internet protocol communications system short message service message, and/or a non-Internet protocol communications system paging channel.

In one embodiment, a softswitch sources the instruction to the mobile communications unit to self-initiate establishment of the Internet protocol connection. If desired, the softswitch can monitor for the presence of the mobile communications unit within an Internet protocol network. For example, pursuant to one embodiment, the softswitch can subscribe to the presence of the mobile communications unit from a presence server. Such presence information can then be used as part of the process to successfully facilitate the establishment of an Internet protocol connection that can be utilized to permit transmission of an Internet protocol-based communication to the mobile communications unit.

So configured, a mobile communications unit can reliably and successfully receive Internet protocol communications without requiring a concurrent always-on Internet protocol connection. Furthermore, these enabling activities are readily achieved with little or no alteration to many of the necessary participants to the overall process and, in particular, require virtually no alteration to the underlying communications protocols themselves. Therefore, for example, legacy systems such as common channel signaling system 7 networks can serve to readily facilitate these approaches. Such improvements can therefore be readily introduced into a legacy system without introducing issues of incompatibility for existing non-participating mobile communications units.

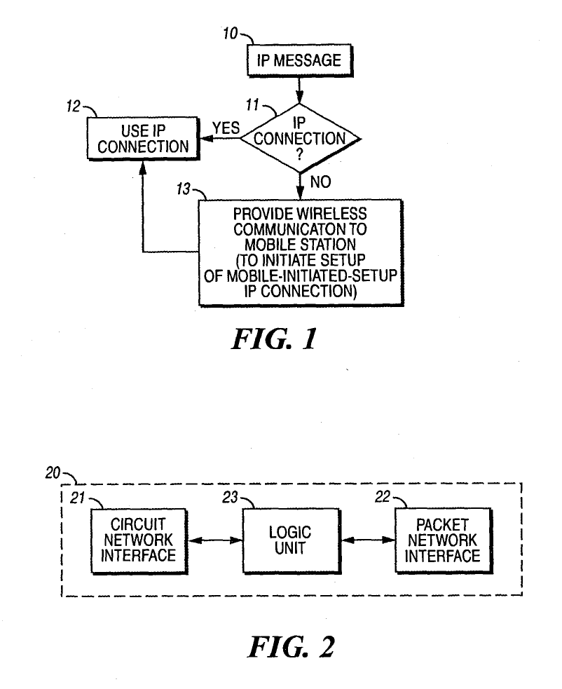

Referring now to FIG. 1, as a general overall perspective, when an Internet protocol (“IP”) message 10 (or other corresponding IP need) exists to forward to a given mobile station, the system determines 11 whether an IP connection to the mobile station already exists (for example, an existing connection through a packet data serving node may be identified). When true, the system uses 12 that existing IP connection to contact and/or otherwise support the desired IP-based activity.

When no existing IP connection exists, however, the system provides 13 a wireless communication to the mobile station wherein the wireless communication includes an instruction to the mobile station to initiate setting up a mobile-initiated-setup IP connection. In general, this wireless communication will comprise a non-IP-based channel. For example, a non-IP communications system control channel, short message service message, and/or paging channel can be successfully utilized to facilitate the conveyance of such an instruction to the mobile station. In a preferred embodiment, the non-IP communications system can comprise a circuit network such as, for example, a common channel signaling system 7 compatible network as are well understood in the art.

So configured, a mobile station can be contacted via a circuit network that the mobile station ordinarily monitors (such as, for example, a 3G wireless network) and provided with an instruction to self-initiate an IP connection. In response, in a preferred embodiment, the mobile station can utilize a self-initiated IP connection establishment protocol that it otherwise ordinarily uses when initiating the setup of an IP network communication link. For example, the mobile station can source a request to a packet data serving node to seek establishment of an IP connection to an IP network. In particular, the mobile station can seek establishment of an IP protocol such as point-to-point protocol as well understood in the art. Once this IP connection has been established by the mobile station, the IP connection can then be used to support the desired IP communication. For example, email can be automatically forwarded to the mobile station without requiring the attention or intervention of the mobile station user. Such capability in turn lends an effective always-on capacity without actually requiring the constant maintenance of the IP connection.

Referring now to FIG. 2, a so-called softswitch 20 can serve a useful role in a preferred implementation of such a system. Generally speaking, such a softswitch 20 should preferably include both a circuit network interface 21 that permits coupling to the mobile station via the referenced circuit network and a packet network interface 22 that couples to a corresponding packet network and via which the softswitch 20 can receive a message from the packet network, which message indicates the desire or need to facilitate the packet-based communications with the mobile station. These interfaces in turn couple appropriately to a logic unit 23. Generally speaking, this logic unit 23 serves to receive the requesting message from the packet network as noted above and to source the instructional message to the mobile station as described above in response thereto. (It will of course be understood that the logic unit 23 of such a softswitch 20 can comprise either an integral mechanism or a plurality of non-integral physical units that collectively comprise a distributed processing platform to effect the various well-understood activities of a softswitch. For example, in one embodiment, the logic unit 23 can comprise various non-integral physical units that support activities such as a session initiation protocol (“SIP”) proxy, a directory server, an authentication, authorization, and accounting (“AAA”) server, and a signaling gateway, all as well understood in the art.) So configured, such a softswitch 20 can readily serve to support the various communications contemplated herein. Specific examples are provided below where appropriate.

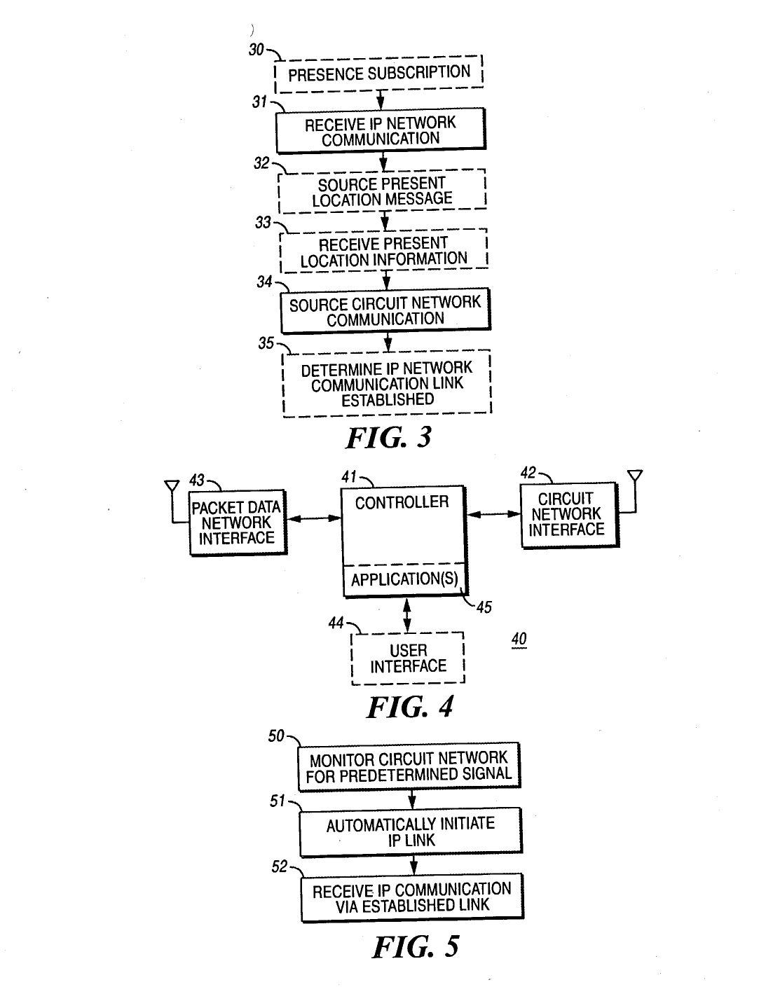

In particular, and referring now to FIG. 3, such a softswitch 20 can serve to receive 31 the IP network communication referenced above that indicates the need to establish an IP network communication link with a given particular mobile station. In response, the softswitch 20 can then source 34 the circuit network communication (or communications) directed to the mobile station that includes the instruction (or instructions) to cause the mobile station to automatically initiate setup of the desired IP network communication link with the requesting IP network.

In one embodiment, the softswitch 20, upon receiving 31 the IP network message, can source 32 a message to request a present location for the given mobile station. Upon receiving 33 a message that comprises a response to this request, the softswitch 20 can use this location information to facilitate appropriately directing the circuit network communication to the desired mobile station. In one embodiment, the location request message can be directed via the circuit network to an appropriate data entity such as, for example, a home location register as well understood in the art.

In another embodiment, the softswitch 20 can determine 35 when and/or whether the mobile station has established the desired IP network communication link subsequent to providing the corresponding instruction thereto. Such a determination can be derived in a variety of ways. For example, the softswitch 20 can receive a notification message via the circuit network to such effect (as sourced, for example, by the mobile station itself). It would also be feasible (and perhaps desirable) to receive such an indication from a presence server (wherein such a presence server would likely submit such a notification via the packet network using an IP-based communication). In general, the softswitch 20 can receive and/or derive an indication of the establishment of the desired IP connection using any of a variety of explicit communications and/or implicit indicia of the setting up of such a link.

Pursuant to yet another embodiment, the softswitch 20 can optionally subscribe 30 to the presence of the mobile station. Pursuant to such a subscription, the softswitch 20 would automatically receive a notification from the IP network when the mobile station has a presence in the IP network (and/or when such a presence has terminated). Such a subscription request could be submitted to a presence server, the latter being understood in the art. By one approach, the softswitch 20 can subscribe to the IP presence of every mobile station within the system. Pursuant to another approach, the softswitch 20 can subscribe, typically on a temporary basis, to the IP presence of only those mobile stations to which the softswitch 20 has (or will) directed the appropriate instructions as described above. To effect the latter approach, the subscription presence 30 would more appropriately be submitted subsequent to receiving 31 the IP network communication that identifies the specific mobile station of interest. The presence criteria can be defined as appropriate to a given system or setting. For example, presence can be determined as a function of a present ability to communicate with the mobile station using an IP connection link.

So configured, it can be readily appreciated that a softswitch 20 can indeed effectively facilitate the described actions with considerable flexibility and efficiency. A concurrent capability of effecting these desired actions in a fashion that remains largely compatible with many existing legacy systems will be demonstrated in more detail below.

With reference to FIG. 4, a mobile station 40 suitable for use in such approaches can be substantially as otherwise is generally well understood in the art. A controller 41 will couple to both a circuit network interface 42 (such as a 3G wireless network compatible transceiver) and a packet data network interface 43 (such as an 802.11(a) or (b) compatible wireless network transceiver) (depending upon the particular channels utilized and other factors and design constraints as well understood in the art, a common transceiver platform may suffice for both interfaces or separate transceivers may instead be used). In a preferred embodiment, the circuit network interface 42 will support, at a minimum, a compatible interface to a common channel signaling system 7 compatible network as well understood in the art.

So configured, the mobile station 40 can support a variety of operating modes, including at least a first and second mode of operation that correspond to the embodiments described above. In particular, for example, the first mode of operation can facilitate a capability of the mobile station to use the packet data network interface 43 to self-initiate the setup of a communication link to a corresponding packet data network. Such a first mode of operation can serve to facilitate IP connections as ordinarily otherwise established pursuant to the needs of various controller applications 45 and/or instructions as received from a user via a user interface 44, all as well understood in the art. The second mode of operation can preferably comprise monitoring for receipt of a circuit network message via the circuit network interface 42 comprising the instruction described above to cause the mobile station to automatically initiate the first mode of operation. (Such a second mode of operation can include other related actions as desired, such as automatically providing a notice via the circuit network interface 42 to, for example, a softswitch as described above, indicating receipt of the instruction message and/or actions in compliance therewith.)

So configured, and referring now to FIG. 5, such a mobile station 40 can readily monitor 50 a given circuit network for a predetermined signal as described above. Such monitoring can include, for example, any of monitoring a circuit network control channel, short message service message, and/or one or more paging channels, which may, in a preferred embodiment, comprise a part of a common channel signaling system 7 compatible network. Upon receiving the appropriate instruction, the mobile station 40 can then automatically initiate 51 establishment of the desired IP link (using, for example, point-to-point protocol (“PPP”) compatible communications) following which the mobile station 40 can receive 52 the corresponding IP-based communication via the establish IP link. So configured, the native capabilities of the mobile station are effectively used to permit automatic IP-based interaction without requiring an always-on IP connection and without necessarily requiring an instruction protocol with communication needs that overwhelm the compatibility requirements of the various networks involved.

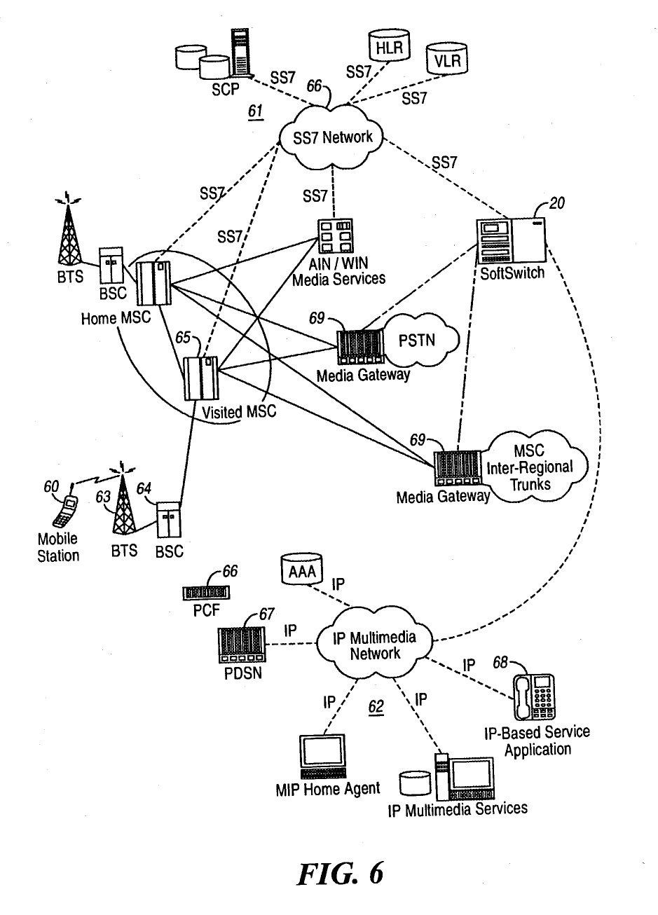

FIG. 6 presents a simplified representation of a 3G Wireless Network architecture including both the circuit and IP multimedia networks 61 and 62. At the network edge, a base transceiver station (“BTS”) 63 provides a wireless link to a mobile station 60, with multiple BTS's typically being under the control of a base station controller (“BSC”) 64. The BSC 64 connects to a mobile services switching center (“MSC”) 65 for circuit-voice (in this example, a visited MSC as understood in the art). Under appropriate operating circumstances, the BSC 64 can also couple to a packet control function (“PCF”) 66 for packet data. MSC's are usually clustered in regions, typically corresponding to geography or metropolitan areas. Within a given region, the MSC's generally form a connected mesh, while separate regions are connected by appropriate trunks (often time division multiplexed (“TDM”) trunks). Each MSC also typically provides public switched telephone network (“PSTN”) connectivity. For purposes of this illustration, two MSC's are shown in FIG. 6 (a home and visited MSC), each with its own set of BSC's and BTS's.

In addition, the illustration includes a representation of an SS7 network 66, as well as some corresponding service elements (a service control point (“SCP”), a home location register (“HLR”), a visitor location register (“VLR”), and a media-based services component, all as well understood in the art).

Note that the depicted network is illustrative only and is not intended to suggest a limit to the actual configuration or topology of any network in which these embodiments may be used.

FIG. 6 also serves to illustrate the relationship of the circuit network 61 and the IP multimedia network 62 to each other, and to the common wireless access infrastructure. From the point at the BSC 64 where the wireless access diverges, the two networks are quite distinct. Connection to the IP network 62 would typically be supported by a point-to-point protocol (“PPP”) tunnel from the mobile station 60 to a packet data serving node (“PDSN”) 67. Once IP presence for the mobile station 60 has been established, either at the PDSN 67 (or a home agent in the case of Mobile IP), the mobile station 60 will have access to whatever IP multimedia services are offered by the user's provider. IP signaling and session management protocols, such as SIP, H.248, and RADIUS, as well as IP multimedia data, are transported on the links labeled “IP” in FIG. 6.

On the circuit side, connection and mobility are maintained by the MSC 65. The MSC 65 provides mobile-to-mobile as well as mobile-to-PSTN circuit services. Landline transport is provided by TDM trunks, subject to the same types of traffic and capacity issues faced in the PSTN. Circuit-side signaling, such as ISUP, TCAP, and ANSI 41, is supported by the links labeled “SS7” in FIG. 6 and as well understood in the art.

Media gateways 69 provide interfaces between the MSC bearer paths (TDM) and assumed core IP networks for transporting voice calls. Although the specific details of the media plane for TDM traffic to and from the serving MSCs are not crucial for the embodiments described herein, the media gateway elements are included in the illustration to underscore the broad range of functions and services provided by a softswitch 20 in both the circuit and IP networks 61 and 62.

In this illustrative embodiment, the softswitch 60 has a interface to the SS7 network 66 for circuit-based signaling, including ISUP, TCAP, and ANSI 41, and an interface to the IP network 62 for IP-based signaling and control protocols, such as SIP, H.323, and H.248. The softswitch 60 preferably includes such network components as SIP proxy servers, protocol translators, media gateway controllers, and signaling gateways. In addition, the softswitch will preferably further support such backend services as directory lookups, admission, authentication and authorization (“AAA”), and accounting and billing; these may be implemented on such components as directory servers, accounting servers, and AAA servers. Subscriber services, including user profile management, presence, and instant messaging are also preferably either provided, supported, or facilitated by the softswitch 60, as well. In a general sense, all of these services and functions, as well as the network elements that deliver them, may be considered as part of the softswitch. Depending upon the exact architecture, of course, the entirety of these functions and elements may in fact be deployed in a single, integrated system.

Finally, FIG. 6 depicts an IP-based service (or application) 68 that seeks a present communication with the mobile station 60 notwithstanding the present lack of an IP connection between the IP-based service (or application) and the mobile station 60. As already noted above, in a preferred embodiment the softswitch 20 can serve to facilitate the establishment of such an IP connection link to permit such a communication.

Pursuant to this illustrative example, the mobile station 60 can be located using existing ANSI 41 messaging to the mobile station's HLR. Once located, either the forward control channel or the paging channel can be used to send a message to the mobile station 60, relaying a request that the mobile station wakeup its IP presence. Alternatively, an SMS message may be sent to the mobile station 60 when the system supports such a service (note that depending upon the message length and current state of the mobile station, SMS may also use the paging channel).

Pursuant to a preferred approach:

The system should preferably have the ability to understand the nature of the request from the IP-based service or application 68 that is attempting to contact the mobile station 60;

The system should preferably have the ability to translate an IP-based identity into a relevant mobile station identity;

The system should preferably have the ability to carry out the appropriate ANSI 41 transactions;

The system should preferably have the ability to monitor the IP presence state of the mobile station 60 in order to recognize when the mobile station's IP virtual presence has entered a state in which the mobile station 60 can communicate with the requesting IP-based service or application 68 (or a proxy for the application); and

The mobile station should preferably be able to recognize the contents of a message received on the control or paging channel (or contents of an SMS message, when used) as a request to initiate IP connectivity, and must be able then to act upon the request.

As already noted, such a combination of functions and capabilities can be effectively facilitated, for the most part, by using an IP-based softswitch 20.

With continued reference to FIG. 6, and for purposes of this example, the mobile station 60 has present radio connectivity with the depicted cellular/circuit network, but no present IP connectivity. The latter state is represented by the absence of a PPP tunnel as well as the underlying connections between the BSC 64 and the PCF 66, and between the PCF 66 and the PDSN 67. In addition, for purposes of this example, the mobile station 60 is registered with a visited MSC 65 rather than with it's home MSC. The latter condition serves to illustrate that these embodiments do not depend upon any specific location of the mobile station so long as the mobile station is reachable by it's home MSC.

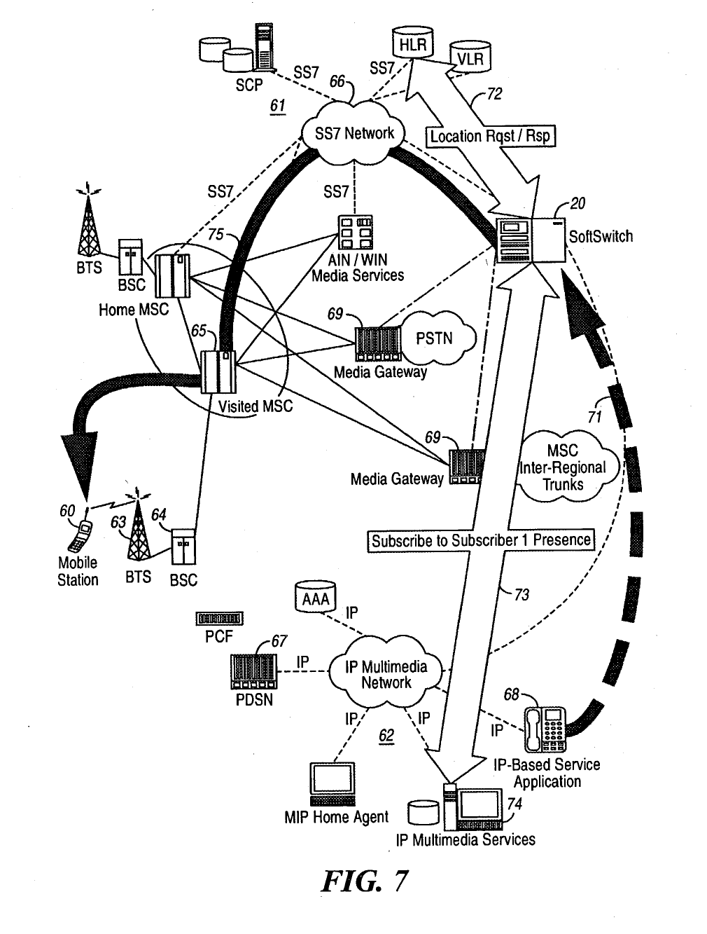

Referring now to FIG. 7, and to continue this example, the IP-based service 68 sources a request 71 to the softswitch 20 to help establish a connection to the mobile station 60. As noted earlier, the IP-based service 68 may have already determined that the mobile station 60 is not online in the IP network 62. In this case, the request 71 might represent an explicit request to the softswitch 20 to wake up the corresponding mobile station 60. Alternatively, the IP-based service 62 may not know that the mobile station 60 is offline. In this case, the request 71 might be a general service delivery protocol message (such as, for example, a SIP INVITE) sent to the softswitch 20 under the assumption that the softswitch 20 will act accordingly to locate the identified mobile station 60 and forward the message.

In either case, the softswitch 20 can then send an ANSI 41 location request message 72 to the HLR. This message 72, as well as the response from the HLR with the location of the mobile station 60, would be sent via the SS7 network 66 (note that both the request and response are shown as message 72 in FIG. 7). The location of the mobile station 60, of course, includes the MSC at which the mobile station 60 can be contacted.

Assuming the HLR response indicates that the mobile station 60 can be reached, and in accord with this particular example, the softswitch 20 communicates 73 with a presence server 74 in the IP multimedia network 62 to subscribe to the user. (As noted earlier, this activity may not actually involve explicit subscription to a presence service, but rather an implicit monitoring of the mobile station's state with respect to the specific service request. For example, as part of the IP wakeup procedure, the mobile station 60 might automatically register with the softswitch 20 component that is monitoring for such presence.)

The softswitch 20 then constructs an ANSI 41 page or SMS message 75 that carries the request to the mobile station 60 to wake up its IP presence, and sends the message 75 to the mobile station 60. The page or SMS message 75 is sent through the SS7 network 66 and delivered to the mobile station 60 via the MSC 65 at which the mobile station 60 is currently registered.

So configured, the protocols and methods for sending both page and SMS messages to the mobile station 60 are part of the current ANSI 41 standard. That is, no new protocols or interfaces are required to support this communication. However, the specific message content is at least partially new, and the mobile station 60 will likely benefit from a small amount of supplemental programming to assure a proper response to the message 75. This comprises a relatively simple addition to mobile station functionality. The more significant requirement is the ability to construct and deliver the message 75 to the mobile station, but this is already supported by the existing deployments and the standards upon which they are based.

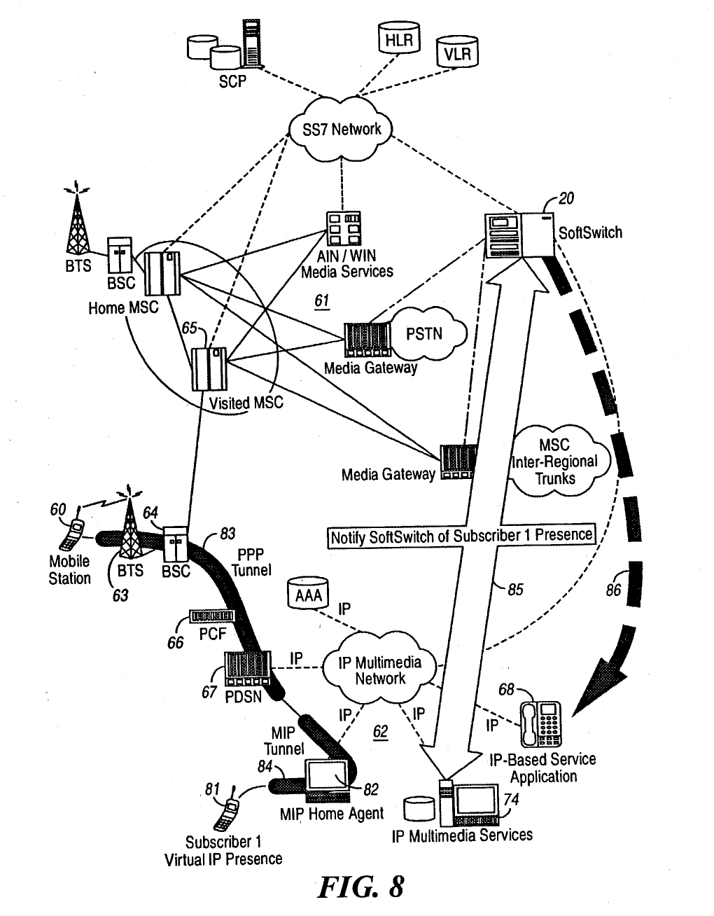

Referring now to FIG. 8, the mobile station 60 acts upon the request by self-initiating an IP connection to the IP network. In this example, the mobile station 60 uses mobile IP as well understood in the art to thereby establish an IP presence 81 at their home agent 82. These connections and IP presence are represented by the PPP tunnel 83 and the mobile IP tunnel 84 that connect the mobile station 60 through the BSC 64, PCF 66, and PDSN 67 to the home agent 82 (and, of course, to the IP multimedia network 62 in general). It should be noted that the user's IP presence could also be supported directly at the PDSN 67 with just the PPP tunnel 83 in the event that Mobile IP is not used.

With the assumption that the mobile station's presence state is monitored by the presence server 74, the softswitch 20 will be sent a notification 85 that the mobile station 60 is now online (i.e., has an IP presence). This notification 85 is sent as a result of the subscription sent by the softswitch 20. Again, depending upon the specific IP-based service or application 68, an actual presence service might not be appropriate or necessary. For example, if part of the IP wakeup procedure includes registration with the softswitch 20 component that is monitoring the mobile station 60, then that registration will serve as the desired notification of IP presence.

The softswitch 20 then notifies 86 the IP-based service 68 that the mobile station 60 is now reachable via the IP network 62. The specific nature of this indication can depend upon the nature of the earlier corresponding request 71 from the IP-based service 68 to the softswitch 20 that began the wakeup request sequence. If the IP-based service 68 was already aware that the mobile station 60 was initially offline, and its request was for an explicit wakeup call to the mobile station 60, then this softswitch notice 86 may be used to trigger the service 68 to now initiate contact with the mobile station 60 using the established connection. On the other hand, if the IP-based service 68 did not know that the mobile station 60 was initially offline, and simply sent a message (e.g., a SIP INVITE) to the mobile station 60 via the softswitch 20, then this notification 86 may comprise a confirmation that the original message has been forwarded to the mobile station 60 (or a response to the original message when such has been received).

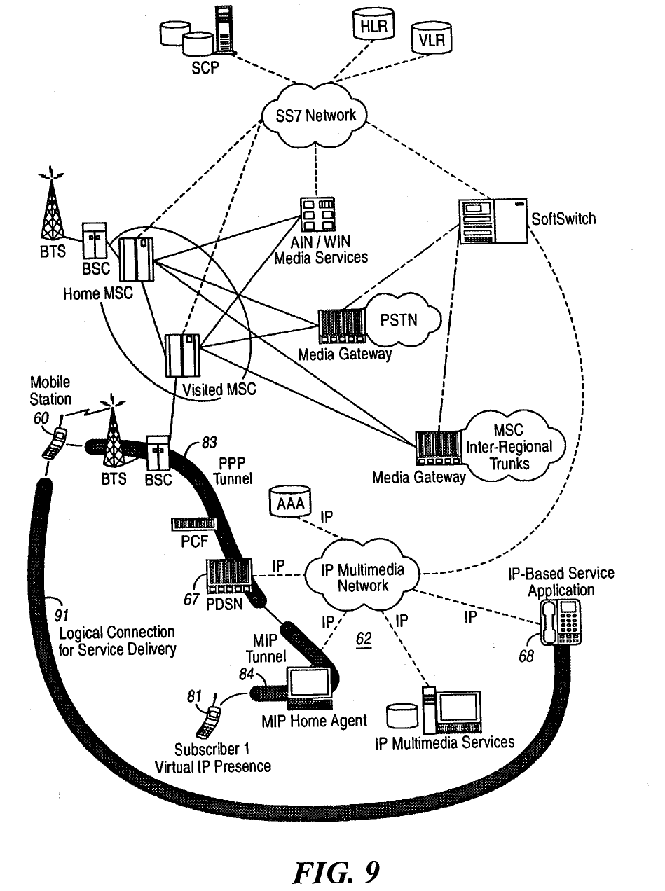

With reference to FIG. 9, the IP-based service 68 and the mobile station 60 may now communicate 91 via the IP multimedia network 62. This communication 91 could comprise the path of a voice-over-IP (“VoIP”) call, the delivery of voicemail, or any other application or service that requires IP connectivity to the mobile station of a system user.

The basic sequences and embodiments outlined above can be implemented in a variety of ways, and can be utilized for a wide range of IP-based services and applications that seek to make IP contact with a mobile station. Additional details appear below.

When an IP-based service or application attempts to communicate with a user, it must usually have some form of addressing information for the user. This can be a direct contact, such as an IP address, or an indirect contact, such as a universal resource locator (“URL”). It is assumed that the attempted IP communication is ultimately preferably routed via the softswitch 20. For example, if a SIP INVITE is addressed with the user's URL, then some IP location service in the network will identify the SIP Proxy component of the softswitch 20 as the user's SIP Proxy. The SIP INVITE will thus be routed to the user's SIP Proxy. The SIP Proxy will then access a location service or directory service associated with the softswitch 20 in order to convert the URL, in this example, to a phone number.

The phone number can then be used in a location request to the user's HLR. Assuming the user can be located, i.e., their mobile station 60 is currently reachable via the wireless network, then the softswitch 20 can use the location information from the HLR to formulate the page or SMS request to the user's mobile station 60 to effect its IP presence. If the HLR response indicates that the user is unreachable, then the softswitch 20 may return this status, possibly as an error, to the requesting function. (For example, this might occur if the user's mobile station is currently powered off.)

The described approach used by the softswitch 20 to signal the mobile station 60 to initiate its IP wakeup exploits the paging capability of the wireless network. In ANSI 41, there are a two basic ways that this can be implemented with minimal impact on existing network elements. The first is to use the ISPAGE (or ISPAGE2) protocol message to signal the mobile station 60. This approach utilizes low-level functionality, requiring formatting of the wakeup request for transport in the ISPAGE (or ISPAGE2) message according to the ANSI 41 specifications. Once the message is constructed, the softswitch 20 transmits the ISPAGE (or ISPAGE2) on its SS7 interface. The message will be delivered to the mobile station 60 over the SS7 network via the serving MSC and BSC. As long as the mobile station 60 can be located, it can receive this message over its paging channel or forward control channel.

As an alternative to the ISPAGE (or ISPAGE2) message, the SMS service can be used to deliver the IP wakeup message. This provides a higher level of application support for short message delivery to the mobile station 60, as well as additional infrastructure for handling responses and confirming receipt by the mobile station 60. Again, the softswitch 20 accesses this capability via its SS7 interface. The message is delivered to the mobile station 60 using either the paging channel or the traffic channel. The choice can be determined by the SMS system; no requirements are necessarily placed on the softswitch 20 to know about which choice is used. It should be noted that SMS might not be available in all networks, all regions, or to all users. This could limit the coverage of IP wakeup service if SMS is used as the exclusive enabling mechanism in a given setting.

When the mobile station 60 receives the ISPAGE (or ISPAGE2) message, it will be decoded to recover the IP wakeup request. If SMS is used, the request would form the content of the SMS message. The mobile station 60 should preferably be able to recognize the request and carry out the appropriate actions that cause the self-initiation of a new data connection to the IP network. This aspect, however, is the only one requiring new capability on the part of any network element. At the same time, however, the functionality required once the message is identified and understood by the mobile station 60 should preferably be a subset of that already implemented by the mobile station 60. That is, a mobile station 60 in a 3G network will typically already support the capability of self-initiating an IP connection to the IP network. The embodiments here simply require that the directive to carry out this function be derived from a message delivered to the mobile station 60 via, for example, a page or SMS message.

The determination that a given mobile station 60 needs to wake up its IP presence can be made at a number of points between the IP-based service or application that wishes to contact the mobile station 60 and the softswitch 20 elements that communicate the wakeup request. Fundamentally, however, where this determination is made, and how the IP wakeup request is formulated and delivered, can be divided into two basic approaches as already suggested above: implicit and explicit.

An implicit wakeup request is one in which the IP-based service or application has no awareness of the IP presence state of the user who it is trying to reach. In this case, the softswitch 20 determines that the user has no IP presence, but that their mobile station 60 may be able to act on a page or SMS message to wake up. The softswitch 20 issues the page or SMS message with the IP wakeup request. Once the IP presence of the mobile station 60 is established, the processing of the IP-based service or application's communications with the mobile station 60 can proceed. An example is a SIP INVITE message for initiation of a VoIP call to the mobile station. The user agent that issues the INVITE waits for a reply from the called party at the mobile station 60, but never knows that the wakeup request was issued and handled by the softswitch 20.

An explicit wakeup request is one in which the IP-based service or application must know the IP address of the user, but determines that the user currently has no IP presence. In this case, the IP-based service or application may make an explicit request to the softswitch 20 to issue a wakeup request. The IP-based service or application may await notification from the softswitch 20 once the mobile station 60 wakes up its IP presence, or explicitly monitor for the IP presence, e.g., via a presence service. This approach requires that the softswitch 20 provide an explicit service for issuing such a wakeup request. Note that this service may include a possible range of responses to the request; e.g., whether or not the user is reachable, whether or not the wakeup request has been successfully issued, and so forth. An example of an explicit wakeup request is a push email service, in which the email server tries to deliver new email notifications to users who are currently offline, but who are willing to respond to requests to go online (if they have the ability to receive such requests). (Both approaches are illustrated below.)

Once an IP wakeup request has been issued to a mobile station 60, the IP presence state of the mobile station 60 should preferably be monitored so that appropriate action(s) can be taken when the IP presence is established. As with the wakeup request itself, the monitoring can be implicit or explicit.

Implicit monitoring is done, for example, without invoking a presence service. Instead, it relies on direct notification from, for example, the mobile station 60 to an appropriate softswitch 20 element once IP presence is established. An example is a SIP proxy server waiting for the mobile station 60 to wakeup following the issuance of a wakeup request. Assuming the SIP proxy server is the serving proxy for the user in question, and assuming that the user automatically registers with the SIP proxy server once they go online, then the registration process will serve as implicit notification.

Explicit monitoring may be done, for example, by invoking a presence service, or other equivalent monitoring service, that is not directly tied to the entity that is awaiting the IP wakeup. In this case, the entity does not expect to receive notification directly from the mobile station 60 once its IP presence is established. Rather, it relies upon the presence service to monitor the user's IP presence, and to send notification when the user comes online (or transitions to some other state that the entity is awaiting). If a presence service is used, then the entity first subscribes to the user's state and then awaits notification. The example of push email above applies here as well. Prior to invoking the explicit wakeup request mechanism of the softswitch 20, the push email service would subscribe to the user's presence state. Once the user is online, the push email service would be notified by the presence service. The push email service could then take action based upon the user's presence (e.g., push-deliver the new email).

The management of wakeup requests and wakeup actions refers generally to how the overall IP wakeup service is tailored to the specific IP-based services or applications that use it. The distinction between implicit and explicit wakeup requests, and implicit and explicit monitoring, are examples of aspects of the service that could be subject to management. Other examples of aspects that may benefit from management include which IP-based services or applications may use wakeup service (i.e., privileges of requestors), filtering unsolicited/unwanted emails or communications, which users may receive wakeup requests, and so forth.

There are at least two general approaches that can be taken to such management. One is mobile station-based and the other is network-based. Mobile service-based management might benefit by requiring additional information to be transmitted to the mobile station 60 during the wakeup request beyond just the request to wakeup. For example, the request could contain the IP address of a contact that is awaiting notification, or the type of service making the wakeup request. This approach encompasses additional requirements on both the mobile station 60 processing software and the softswitch 20 elements that construct and send the wakeup message. In addition, the length of the message might become an issue for page or SMS messages.

The network-based approach may, in one embodiment, assume that there is only one type of IP wakeup message sent to the mobile station, and the actions of the mobile station 60 are either to decline the request or honor it by initiating a request to establish its IP presence. The softswitch 20 and softswitch-associated network elements may include features and information used to manage and respond to the actions that follow the determination that a wakeup request is needed. A partial list of some potential useful types of features and information follows below. This list is not intended to be complete, but to illustrate a range of applications.

AAA services and user profile. This could be used to filter unsolicited/unwanted emails or communications. This could also contain user preferences, including whether or not the user has and/or authorizes wakeup service to their mobile station. Other user preferences could also be managed in this manner.

Presence Server. This could filter which other users or applications are authorized to subscribe to the user's presence.

System authorization. This could be used to determine which services and applications are permitted to make wakeup requests to the softswitch 20. This is similar to the user profile, but could be applied on a system wide basis.

In addition, configuration details, such as which databases contain user identification mappings (e.g., URL-phone number), directory information, and so forth, may be broadly considered management of aspects of the method and system of IP wakeup service. While this is also related to implementation, it underscores the types of information that might be usefully considered in order to customize the service for a specific set of application requirements.

Two examples of an application of such an IP wakeup service will now be presented. The first example is applied to the setup of a new VoIP call. This first example will illustrate the use of implicit request and implicit monitoring for IP presence. The second example is applied to push email. This second example illustrates the case of explicit request and explicit monitoring. These examples are not intended to be limiting or exhaustive, and other applications of the system and method can of course be supported.

### EXAMPLE 1

### VoIP Call Setup

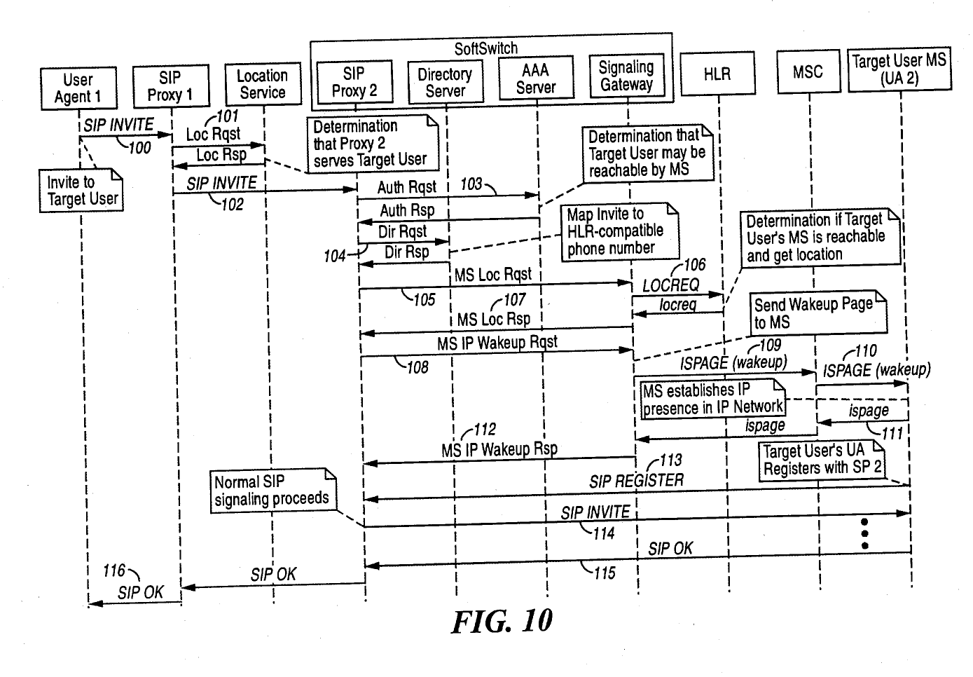

FIG. 10 shows the initial portion of a pseudo call flow for the setup of an IP telephony call using SIP for signaling and the IP wakeup method described above to cause the mobile station 60 to wakeup its IP presence. It is assumed that the mobile user is not initially online (nor registered with a SIP Proxy) at the time the call is made. For purposes of clarity and brevity, this call flow portrays signaling only from initial SIP INVITE through the responding SIP OK messages. Note also that four of the network elements in the illustration are grouped together as an integrated softswitch 20. This configuration is for explanatory purposes, and other arrangements are of course possible.

A brief description according to the reference numbers presented in FIG. 10 follows. (In the steps below, quotation marks are used on the first introduction of each of the network elements in this figure; thereafter, the quotation marks are dropped.)

100—The originating user, represented by “User Agent 1,” sends a SIP INVITE message to the “Target User,” represented by “UA 2” and physically hosted on the mobile station “Target User MS.” Target User may be identified by a phone number or URL. In this example, User Agent 1 sends the SIP INVITE to “SIP Proxy 1,” indicating that User Agent 1 may be registered with SIP Proxy 1.

101—SIP Proxy 1 uses a “Location Service” to determine the serving proxy for UA 2. The Location Service identifies “SIP Proxy 2” as the serving proxy for UA 2, and returns this information to SIP Proxy 1. Note that SIP Proxy 1 and the Location Service are not shown as elements of an integrated softswitch, while SIP Proxy 2 is. This is only for illustrative purposes.

102—SIP Proxy 1 forwards the SIP INVITE to SIP Proxy 2.

103—Since UA 2 (Target User) is not currently registered with SIP Proxy 2, SIP Proxy 2 queries the “AA Server” for contact information. The AAA Server's response indicates that Target User may be reachable via their MS, and may include Target User's HLR. Target User may configure his/her user profile in the AAA Server to filter such requests, e.g., controlling which callers are allowed to issue (directly or indirectly) IP wakeup requests.

104—SIP Proxy 2 queries the “Directory Server” for an HLR-compatible phone number for Target User's MS. This could be a mapping from URL to cell phone number.

105—SIP Proxy 2 sends a location request to the “Signaling Gateway” in order to find the current location of the MS. The message shown is a pseudo protocol, which could be either proprietary or standard as appropriate to the contextual setting.

106—The Signaling Gateway creates an ANSI 41 LOCREQ message and forwards it to Target User's “HLR.” The HLR responds with an ANSI 41 locreq message, indicating the current serving “MSC” for Target User's MS.

107—The Signaling Gateway relays to SIP Proxy 2 the response to the location request query, again shown with a pseudo protocol.

108—SIP Proxy 2 sends a wakeup request to the Signaling Gateway.

109—The Signaling Gateway creates an ANSI 41 ISPAGE message for Target User's MS, and sends it to the serving MSC. Note that an alternative method might be to use an SMS message.

110—The serving MSC forwards the ISPAGE message to the MS. The MS must be able to decode the request sent in the page (or SMS) message and act upon it.

111—The MS responds with an ispage, which is forwarded back to the Signaling Gateway. It is assumed that the MS sends a request to the PDSN for a PPP connection, initiating a sequence that will establish the IP presence of the MS.

112—The Signaling Gateway translates the ispage into an affirmative response to the request of SIP Proxy 2 made earlier.

113—Once the MS has established its IP presence in the IP network, its User Agent (UA 2 in this illustration) registers with its SIP Proxy (SIP Proxy 2 in this illustration).

114—SIP Proxy 2 recognizes the registration of UA 2, and now forwards the original SIP INVITE.

115—After any possible intermediate messages (as represented by the vertical ellipses) UA 2 sends a SIP OK to SIP Proxy 2, which forwards the OK to SIP Proxy 1.

116—User Agent 1 receives the SIP OK in response to its initial SIP INVITE. At this point, any further SIP signaling and/or IP communications between User Agent 1 and UA 2 proceeds in ordinary course via the established communication link.

The disclosed sequence and messages presented in this example are not meant to limit in any way other possible sequences and messages that implement the IP wakeup service as otherwise described and suggested herein.

### EXAMPLE 2

### Push Email

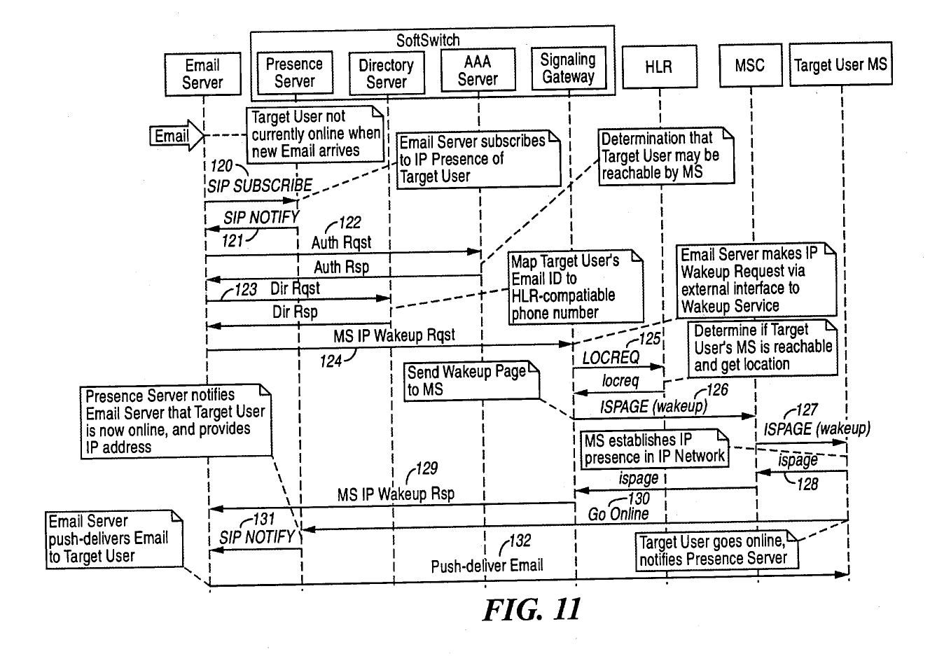

FIG. 11 shows the a pseudo call flow for the delivery of email to a mobile user by a push email service using an IP wakeup method in accordance with one embodiment of these teachings to cause the MS to wakeup its IP presence. As in the previous example, it is assumed that the mobile user is not online at the time a new email becomes available for delivery to the MS. (Note also that again four of the network elements in the illustration are grouped together as an integrated softswitch. This configuration is for illustrative purposes, and other arrangements are possible.)

A brief description according to the reference numerals presented in FIG. 11 follows. As in the previous example, quotation marks are used on the first introduction of each of the network elements; thereafter, the quotation marks are dropped. The sequence begins with the arrival of a new email, shown at the top left of the figure.

120—The “Email Server” receives the new email and determines that the intended recipient is not currently logged. It sends a SIP SUBSCRIBE message to the “Presence Server” in order to be notified when “Target User” establishes IP presence.

121—The Presence Server responds with a NOTIFY message indicating that the subscription has been made (as per the SIP standard for event notification).

122—The Email Server queries the “AAA Server” for contact information. The AAA Server's response indicates that Target User may be reachable via their MS, and may include Target User's HLR. Target User may configure their user profile in the AAA Server to filter such requests, e.g., controlling which callers are allowed to issue (directly or indirectly) IP wakeup requests.

123—The Email Server queries the “Directory Server” for an HLR-compatible phone number for Target User's MS. This could be a mapping from URL or email account name to cell phone number.

124—The Email Server sends a wakeup request to the “Signaling Gateway” (or some other appropriate intermediary process).

125—The Signaling Gateway creates an ANSI 41 LOCREQ message and forwards it to Target User's “HLR.” The HLR responds with an ANSI 41 locreq message, indicating the current serving “MSC” for Target User's MS.

126—The Signaling Gateway creates an ANSI 41 ISPAGE message for Target User's MS, and sends it to the serving MSC. Note that an alternative method might be to use an SMS message.

127—The serving MSC forwards the ISPAGE message to the MS. The MS decodes the request sent in the page (or SMS) message and acts upon it.

128—The MS responds with an ispage, which is forwarded back to the Signaling Gateway. It is assumed that the MS sends a request to the PDSN for a PPP connection, initiating a sequence that will establish the IP presence of the MS.

129—The Signaling Gateway translates the ispage into an affirmative response to the earlier request of the Email Server.

130—Target User's MS, or its agent in the IP network, notifies the Presence Server that it is now online.

131—The Presence Server sends a SIP NOTIFY message to the Email Server indicating that Target User is now online.

132—The Email Server delivers the email to Target User.

Note that there are a few differences between this call flow and the one for SIP call setup as portrayed in the first example above. For example, the Email Server directly accesses the softswitch elements in using the IP wakeup service. For example, the Email Server sends an explicit IP wakeup request to the Signaling Gateway aspect of the softswitch. The Email Server also explicitly subscribes to Target User's IP presence and receives notification directly from the Presence Server. Another difference is that the Signaling Gateway makes the MS location request to the HLR on behalf of the Email Server whereas SIP Proxy 2 in the previous example sent its own location request to the HLR.

These and other elements of both examples are illustrations, and are not intended to limit the actual messages and sequences that could be used in implementing an IP wakeup service for mobile communications units. It should also be understood that the SIP call and push email examples presented here are only illustrations that are suggestive of the types of services and applications that could use IP wakeup service. Other examples of services that could user IP wakeup service are Push-to-Talk, advertisement delivery, instant messaging, and call forwarding to IP telephony devices. This list is not intended to be exhaustive.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method for communicating via an Internet Protocol connection with a mobile station, comprising:
when an Internet Protocol connection already exists, using the Internet Protocol connection to communicate with the mobile station;
when an Internet Protocol connection does not already exist:
providing a wireless communication to the mobile station comprising at least an instruction to initiate setup of a mobile-initiated-setup Internet Protocol connection;
upon successful establishment of the Internet Protocol connection, the setup of which was initiated by the mobile station, using the Internet Protocol connection to communicate with the mobile station.

2. The method of claim 1, wherein using the Internet Protocol connection to communicate with the mobile station includes using a packet data serving node.

3. The method of claim 2, wherein using a packet data serving node includes using a packet data serving node that is operably coupled to an Internet Protocol network.

4. The method of claim 1, wherein providing a wireless communication to the mobile station comprising at least an instruction to form a mobile-initiated-setup Internet Protocol connection includes using at least one of:
a non-Internet Protocol communications system control channel;
a non-Internet Protocol communications system short message service message;
a non-Internet Protocol communications system paging channel.

5. The method of claim 4 wherein providing a wireless communication to the mobile station comprising at least an instruction to form a mobile-initiated-setup Internet Protocol connection includes using a circuit network.

6. The method of claim 5 wherein using a circuit network includes using a common channel signaling system 7 compatible network.

7. The method of claim 1 wherein the setup as initiated by the mobile station comprises at least a request to a packet data serving node (PDSN) to establish an Internet Protocol connection to an Internet Protocol network.

8. The method of claim 7 wherein the Internet Protocol connection established as a result of mobile-initiated setup uses point-to-point protocol (PPP).

9. A softswitch for use in combination with a circuit network and a packet network, comprising:
a packet network interface operably coupled to the packet network and that receives a first message from the packet network seeking to facilitate packet-based communications with a mobile communications unit, which mobile communications unit is compatible with both the circuit network and the packet network;
a circuit network interface operably coupled to the mobile communications unit via the circuit network;
a logic unit that is operably coupled to the packet network interface and the circuit network interface, wherein the logic unit has a first mode of operation pursuant to which the logic unit provides a communication to the mobile communications unit via the circuit network in response to the first message, which communication comprises an instruction to cause the mobile communications unit to automatically initiate setup of a communications link via the packet network.

10. The softswitch of claim 9 wherein the packet network comprises an Internet Protocol compatible network.

11. The softswitch of claim 9 wherein the circuit network comprises a common channel signaling system 7 compatible network.

12. The softswitch of claim 9 wherein the communication comprises at least one of:
a circuit network wireless control channel communication;
a circuit network wireless short message service communication;
a circuit network wireless paging channel communication.

13. The softswitch of claim 9 wherein the logic unit further comprises message means for forming the communication in response to receiving the first message.

14. The softswitch of claim 9 wherein the logic unit is comprised of a plurality of non-integral physical units.

15. A method comprising:
receiving a first communication from an Internet Protocol network indicating a need to establish an Internet Protocol network communication link with at least one particular mobile communications unit;
sourcing a second communication via a circuit network to the at least one particular mobile communications unit, which second communication includes at least one instruction to cause the at least one particular mobile communications unit to automatically initiate setup an Internet Protocol network communication link with the Internet Protocol network.

16. The method of claim 15 and further comprising:
sourcing a message to request a present location for the at least one particular mobile communications unit;
receiving a message comprising a response to the request for a present location.

17. The method of claim 16 wherein sourcing a message to request a present location includes directing the message to a home location register.

18. The method of claim 16 wherein sourcing a message to request a present location includes directing the message using the circuit network.

19. The method of claim 15 and further comprising
determining that an Internet Protocol network communication link with the Internet Protocol network has been established with the at least one particular mobile communications unit.

20. The method of claim 19 wherein determining that an Internet Protocol network communication link with the Internet Protocol network has been established with the at least one particular mobile communications unit includes receiving a notification message from the at least one particular mobile communications unit.

21. The method of claim 20 wherein receiving a message from the at least one particular mobile communications unit includes receiving the notification message via the circuit network.

22. The method of claim 19 wherein determining that an Internet Protocol network communication link with the Internet Protocol network has been established with the at least one particular mobile communications unit includes receiving an explicit communication regarding such action.

23. The method of claim 22 wherein receiving an explicit communication regarding such action includes receiving an explicit communication regarding such action from a presence server.

24. The method of claim 23 wherein the explicit communication from the presence server is made using the Internet Protocol.

25. The method of claim 22 wherein receiving an explicit communication regarding such action includes receiving an explicit communication regarding such action from the at least one particular mobile communications unit.

26. The method of claim 19 wherein determining that an Internet Protocol network communication link with the Internet Protocol network has been established with the at least one particular mobile communications unit includes using implicit indicia of setting up the link.

27. The method of claim 15 and further comprising:
providing a request to the Internet Protocol network to establish a subscription to presence of the at least one particular mobile communications unit in the Internet Protocol network.

28. The method of claim 27 wherein the presence of the at least one particular mobile communications unit in the Internet Protocol network includes at least an ability to communicate with the mobile communications unit using the Internet Protocol.

29. The method of claim 27 wherein the subscription to the presence of the at least one particular mobile communications unit in the Internet Protocol network includes at least a request to receive notification from the Internet Protocol network when the mobile communications unit has a presence in the Internet Protocol network.

30. The method of claim 27 wherein the request to establish a subscription to the presence of the at least one particular mobile communications unit in the Internet Protocol network is directed to a presence server using the Internet Protocol.

31. The method of claim 27 wherein determining that an Internet Protocol network communication link with the Internet Protocol network has been established with the at least one particular mobile communications unit includes receiving a notification from the Internet Protocol network pursuant to the subscription.

32. The method of 31 wherein the notification of the presence of the at least one particular mobile communications unit in the Internet Protocol network is sent by the presence server using the Internet Protocol.

33. The method of claim 15 wherein the at least one instruction automatically causes initiation of the setting up of the Internet Protocol network communication link in a manner substantially similar to how the at least one mobile communication unit ordinarily initiates the setup of an Internet Protocol network communication link.

34. A mobile communications unit, comprising:
a packet data network interface;
a circuit network interface;
a first mode of operation that includes use of the packet data network interface to initiate the setup of a communication link to a corresponding packet data network;
a second mode of operation comprising monitoring receipt of a circuit network message via the circuit network interface, such that upon receiving such a circuit network message the mobile communications unit automatically initiates the first mode of operation.

35. The mobile communications unit of claim 34 wherein the circuit network interface comprises a wireless interface.

36. The mobile communications unit of claim 35 wherein the wireless interface comprises an interface to a common channel signaling system 7 compatible network.

37. The mobile communications unit of claim 34 wherein the first mode of operation is further responsive to at least one of a user interface and an application.

38. The mobile communications unit of claim 34 wherein, further pursuant to the second mode of operation, the mobile communication unit provides a notice, via the circuit network interface, of establishment of the communication link to the corresponding packet data network.

39. The mobile communications unit of claim 34 and further comprising monitoring means for monitoring at least one of:
a circuit network control channel;
a circuit network short message service message;
a circuit network paging channel;
for the circuit network message.

40. The mobile communications unit of claim 34 wherein the first mode of operation includes use of the packet data network interface to initiate setup of a point-to-point protocol (PPP) compatible communication.

41. A method for use by a mobile communications device, comprising:
when an Internet Protocol communications link exists:
receiving an Internet Protocol compatible communication via the Internet Protocol communications link;
when the Internet Protocol communications link does not exist:
monitoring a circuit network for receipt of a predetermined signal;
upon receiving the predetermined signal, automatically initiating setting up of an Internet Protocol compatible communications link to provide an established link;
receiving an Internet Protocol compatible communication via the established link.

42. The method of claim 41 wherein monitoring a circuit network for receipt of a predetermined signal includes at least one of:
monitoring a circuit network control channel;
monitoring a circuit network short message service message;
monitoring a circuit network paging channel.

43. The method of claim 41 wherein automatically initiating setting up of an Internet Protocol compatible communications link to provide an established link includes automatically providing a notice corresponding to such establishment via the circuit network.

44. The method of claim 41 wherein monitoring a circuit network includes monitoring a common channel signaling system 7 compatible network.

45. The method of claim 41 wherein automatically initiating setting up of an Internet Protocol compatible communications link includes using point-to-point protocol (PPP) compatible communications.
